(19) United States
(12) Patent Application Publication
(10) Pub. No.: US 2025/0168027 A1
(43) Pub. Date: May 22, 2025

(54) SYSTEMS AND METHODS FOR APPLICATION-ENABLED MULTICAST CONTROL

(71) Applicant: Verizon Patent and Licensing Inc., Basking Ridge, NJ (US)

(72) Inventors: David Taft, Keller, TX (US); Lap Tse, Marietta, GA (US); Francisco Xavier Sevilla Rubi, Eden Prairie, MN (US); Jacob Benjamin Spahr, Charlotte, NC (US)

(21) Appl. No.: 18/512,787

(22) Filed: Nov. 17, 2023

(51) Int. Cl. H04L 12/18; H04L 65/40

(52) U.S. Cl. CPC H04L 12/185; H04L 65/40

(57) ABSTRACT

Systems and methods provide for application-enabled multicast control. A network device receives first parameters for an application executed on a first user equipment (UE) device and receives second parameters for the application executed on a second UE device. The network device detects, based on the first and second parameters, a multicast opportunity for the application and provides, to an application server for the first UE device and the second UE device, a multicast target address to initiate multicast streaming to the first UE device and the second UE device.

### BACKGROUND

To satisfy the needs and demands of users of mobile communication devices, providers of wireless communication services continue to improve and expand available services as well as networks used to deliver such services. One aspect of such improvements includes the development of wireless access networks which may multicast content to a particular geographic area and/or a particular group of users. Using multicast services, a mobile network operator (MNO) may efficiently provide content to multiple wireless devices. However, precisely targeting geographic areas for specific services may be a challenge with existing multicast services.

### BRIEF DESCRIPTION OF THE DRAWINGS

FIG. 1 is a diagram illustrating a network environment in which a dynamic multicast service can be provided;

FIG. 2 is a block diagram illustrating communications of a multicast controller framework, according to an implementation described herein;

FIGS. 3A and 3B are signal flow diagrams illustrating communications to provide the dynamic multicast service, according to an implementation described herein;

FIGS. 4-6 are diagrams illustrating use cases of the dynamic multicast service;

FIG. 7 is a diagram illustrating exemplary components of a device that may be included in a component described herein; and

FIG. 8 is a flow diagram illustrating an exemplary process for providing the dynamic multicast service, according to an implementation described herein.

### DETAILED DESCRIPTION

The following detailed description refers to the accompanying drawings. The same reference numbers in different drawings identify the same or similar elements. Also, the following detailed description does not limit the invention.

Fifth Generation (5G) core network architectures provide a framework that allows third parties to enable multicast streaming within the service providers network. This framework is generic in nature and leverages the Network Exposure Function (NEF) and Application Functions (AF) influenced capabilities. Using multicast streams, data is sent from one point to a set of many points, where users have previously elected to receive the data. Thus, multicast streams are typically requested and arranged in advance of a multicast streaming event. However, there are instances where different users may be receiving the same content at the same time and providers could benefit from a dynamic selection of multicast to deliver the common content. 5G systems do not currently permit dynamic selection of multicast, which could be used to reduce the number of individual unicast traffic flows in some use cases. For example, when appropriate conditions are detected, multicast could be used to allow both an application and a service providers' network to reduce the number of unicast streams (such as video streams), thereby reducing the number of unicast sessions with, and the amount of bandwidth used by, the hosting server.

Systems and methods described herein provide a dynamic multicast service. The dynamic multicast service may allow a 5G system to offer multicast enablement to third parties. When two or more subscribers use a third-party application (e.g., a gaming application, augmented reality application, vehicle-to-everything application, a video application, etc.) that utilizes common network resources, the dynamic multicast service may allow the application and the network to be aware of the user conditions and utilize multicast streaming if possible, reducing unicast sessions and data transfer bandwidth.

The dynamic multicast service may support a variety of use cases. One example use case includes multiple subscribers playing a game together (e.g., using a gaming application) on the same radio access network (RAN) sector, and/or in the same location, according to a distance threshold. Another example use case includes multiple vehicles communicating to the same RAN sector for the same content. Still another example, a use case includes grouping of multiple fixed wireless access (FWA) devices that are receiving the same video content (e.g., a concert or sporting event). In another use example, multicast may be used for providing local advertising that can be directed to the neighborhood or community level or sub-groups therein. Other use cases may apply.

In one implementation, the dynamic multicast service includes a new application function (AF), referred to herein as a Multicast Controller Framework, that dynamically enables multicast streaming under applicable conditions. The Multicast Controller Framework may use parameters from the user equipment (UE) application (or an Application Wrapper) and permit the application servers to indicate to the RAN, Core, Transport, and other network functions when such conditions exist. The Multicast Controller Framework may inform an application server when a multicast opportunity exists, allowing the application server the option to initiate a multicast request. Thus, instead of statically reserving network capacity in anticipation of a third party wanting to broadcast something using that reserved capacity, the dynamic multicast service may dynamically enable multicast streaming when and where possible, reducing the amount of unicast sessions and data transfer bandwidth.

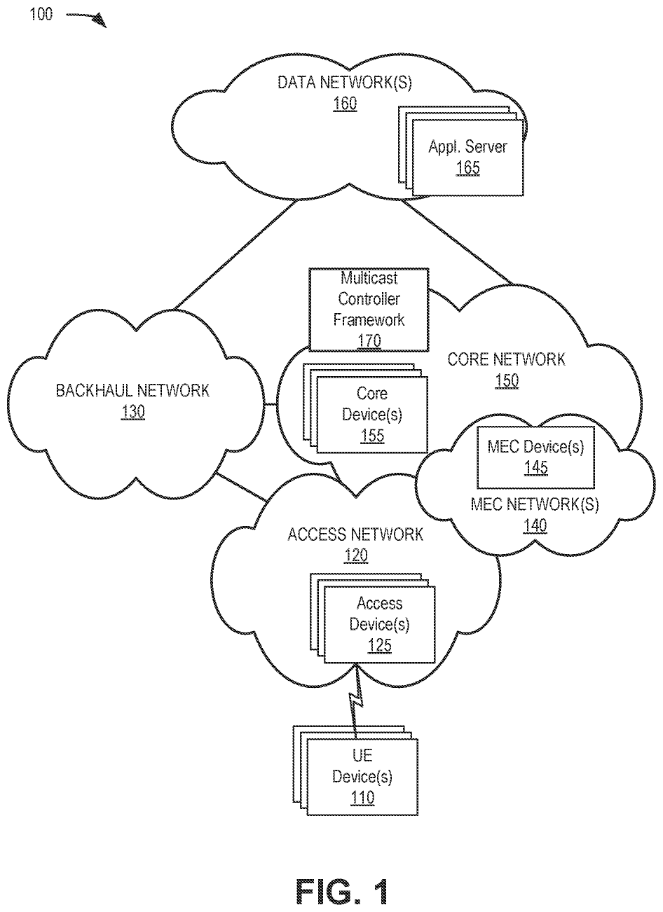

FIG. 1 is a diagram of an exemplary environment 100 in which the dynamic multicast service described herein may be implemented. As shown in FIG. 1, environment 100 may include User Equipment (UE) devices 110 (also referred to as UEs 110), an access network 120 that includes access devices 125, a backhaul network 130, multi-access edge computing (MEC) networks 140 that include MEC devices 145, a core network 150 that includes core devices 155, one or more data networks (DNS) 160 that include applications servers 165, and a Multicast Controller Framework 170. Access network 120, backhaul network, MEC network 140, and core network 150 may be referred to herein collectively as a mobile network, which may be owned/operated by the same service provider.

UE device 110 may include a device with cellular wireless communication functionality. For example, UE device 110 may include a handheld wireless communication device (e.g., a smart phone, etc.), a wearable computer device (e.g., a wristwatch computer device, etc.), a computer; a Wi-Fi® access point, a Fixed Wireless Access (FWA) device, a Customer Premises Equipment (CPE) device, a portable gaming system, an Internet-of-Things (IoT) device, a vehicle-to-everything (V2X) device, and/or any other type of computer device with wireless communication capabilities. UE device 110 may include capabilities for voice communication, mobile broadband services (e.g., video streaming, real-time gaming, premium Internet access etc.), best effort data traffic, and/or other types of applications. In some instances, a “user” or “subscriber” (not shown) may own, operate, and/or administer each UE device 110.

Access network 120 may include a RAN or other type of network to connect UE devices 110 to other networks (e.g., backhaul network 130, MEC network 140, core network 150, etc.). Access network 120 may include an access device 125, which may comprise a 5G New Radio (NR) base station (e.g., a gNodeB) and/or a Fourth Generation (4G) Long Term Evolution (LTE) base station (e.g., an eNodeB). Each access device 125 may include devices and/or components configured to enable cellular wireless communication with UE devices 110. For example, access device 125 may include a radio frequency (RF) transceiver configured to communicate with UE devices 110 using a 5G NR air interface using a 5G NR protocol stack, a 4G LTE air interface using a 4G LTE protocol stack, and/or using another type of cellular air interface.

Access network 120 may enable UE devices 110 to connect to backhaul network 130, MEC network 140, and/or core network 150 via access devices 125 using cellular wireless signals. For example, access network 120 may include one or more central units (CUs) and distributed units (DUs) (not shown in FIG. 1) that enable and manage connections from UE devices 110 to core network 150. Access network 120 may include features associated with an LTE Advanced (LTE-A) network and/or a 5G core network or other advanced network, such as management of 5G NR base stations; carrier aggregation; advanced or massive multiple-input and multiple-output (MIMO) configurations (e.g., an 8×8 antenna configuration, a 16×16 antenna configuration, etc.); relay stations; Heterogeneous Networks (HetNets) of overlapping small cells and macrocells; Self-Organizing Network (SON) functionality; Machine-type Communications (MTC) functionality, such as 1.4 Megahertz (MHz) wide enhanced MTC (eMTC) channels (also referred to as category Cat-M1), Low Power Wide Area (LPWA) technology such as Narrow Band (NB) IoT (NB-IoT) technology, and/or other types of MTC technology; and/or other types of LTE-A and/or 5G functionality.

Backhaul network 130 includes one or multiple networks of one or multiple types and technologies. According to an implementation, backhaul network 130 includes a backbone network. For example, the backbone network may be implemented as an optical transport network, an ultra-high capacity wireless backhaul network, an Ethernet backhaul network, a dark fiber network, or another suitable architecture (e.g., Internet Protocol (IP)/Multiprotocol Label Switching (MPLS), millimeter wave technology, etc.). Depending on the implementation, backhaul network 130 may include switches, routers, repeaters, various types of optical network elements (e.g., multiplexers, de-multiplexers, switches, transmitters, receivers, etc.), and/or other types of network devices. Backhaul network 130 may also include a fronthaul network.

Each MEC network 140 may be associated with one or more access devices 125 and may provide MEC services for UE devices 110 attached to the one or more access devices 125. MEC network 140 may be in the proximity of one or more access devices 125 from a geographic and network topology perspective, thus enabling low latency communication with UE devices 110 and/or access devices 125. As an example, MEC network 140 may be located on the same site as one of the access devices 125. As another example, MEC network 140 may be geographically closer to access devices 125 and reachable via fewer network hops and/or fewer switches than other access devices 125. As yet another example, MEC network 140 may be reached without passing through a gateway device, such as a 4G Packet Data Network Gateway (PGW) or a 5G User Plane Function (UPF). MEC network 140 may include one or more MEC devices 145. MEC devices 145 may provide MEC services to UE devices 110, such as, for example, content delivery of streaming audio and/or video, cloud computing services, authentication services, etc.

Core network 150 may be managed by a provider of cellular wireless communication services and may manage communication sessions of users connecting to core network 150 via access network 120. For example, core network 150 may establish an Internet Protocol (IP) connection between UE devices 110 and DN 160. In some implementations, core network 150 may include a 5G core network.

Core network 150 may include core devices 155. Core device 155 may include a 5G network function; a 4G network node; a transport network device, such as, for example, a switch, router, firewall, gateway, an optical switching device (e.g., a reconfigurable optical add-drop multiplexer, etc.), and/or another type of network device. Core devices 155 may include devices that implement network functions such as, among others, an Access and Mobility Management Function (AMF); a Session Management Function (SMF); a UPF; an NEF to expose services to third-party servers; an Application Function (AF) to provide services associated with a particular application; a path computation element (PCE), a Unified Data Management (UDM); and a Network Slice Selection Function (NSSF). In other implementations, core devices 155 may also include functions for a 4G LTE core network (e.g., an evolved packet core (EPC) network).

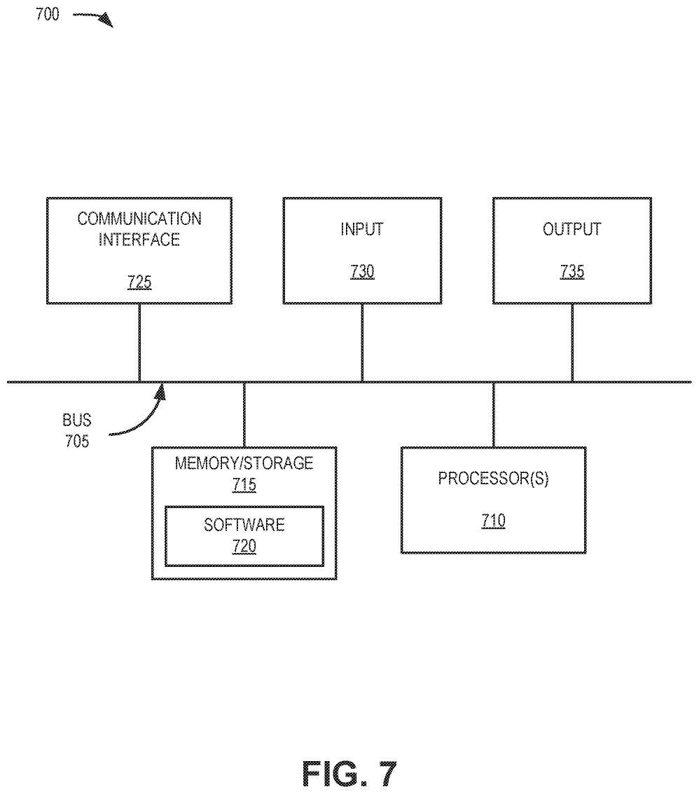

Core device 155 may include a physical function node or a virtual network function (VNF). Thus, the components of core network 150 may be implemented as dedicated hardware components and/or as VNFs implemented on top of a common shared physical infrastructure using Software Defined Networking (SDN). For example, an SDN controller may implement one or more of the components of core network 150 using an adapter implementing a VNF virtual machine, a Containerized Network Function (CNF), an event driven serverless architecture interface, and/or another type of SDN architecture. The common shared physical infrastructure may be implemented using one or more devices 700 described below with reference to FIG. 7 in a cloud computing center associated with core network 150. Additionally, or alternatively, some or all of the common shared physical infrastructure may be implemented using one or more MEC devices 145.

Data networks 160 may each be associated with an Access Point Name (APN) and UE device 110 may request a connection to a particular data network 160 using the APN. Data networks 160 may include, and/or be connected to and enable communication with, a local area network (LAN), a wide area network (WAN), a metropolitan area network (MAN), an autonomous system (AS) on the Internet, an optical network, a cable television network, a satellite network, a wireless network (e.g., a general packet radio service (GPRS) network, and/or an LTE network), an ad hoc network, a telephone network (e.g., the Public Switched Telephone Network (PSTN) or a cellular network), an intranet, or a combination of networks. Data network 160 may include one or more application servers 165. An application server 165 may provide services for a program or an application running on UE device 110 and may establish communication sessions with UE device 110 via access network 120 and core network 150.

Multicast controller framework 170 may include a network device or application function to dynamically enable multicast streaming when and where possible. Multicast controller framework 170 may be located within an application control plane, for example. Multicast controller framework 170 may receive application and service parameters for an application executing on multiple UE devices 110. Additionally, multicast controller framework 170 may receive application requirements (e.g., service level requirements) from application servers 165. Multicast controller framework 170 may detect, based on the first and second parameters, a multicast opportunity (e.g., that meets the service level requirements) for the application. Multicast controller framework 170 may provide, to application server 165 for the UE devices 110, a multicast target address to initiate multicast streaming to UE devices 110. While shown in FIG. 1 as part of core network 150, in other implementations, multicast controller framework 170 may be a distributed component including components in other networks (e.g., access network 120, MEC network 140, etc.)

Although FIG. 1 shows exemplary components of environment 100, in other implementations, environment 100 may include fewer components, different components, differently arranged components, or additional components than depicted in FIG. 1. Additionally, or alternatively, one or more components of environment 100 may perform functions described as being performed by one or more other components of environment 100.

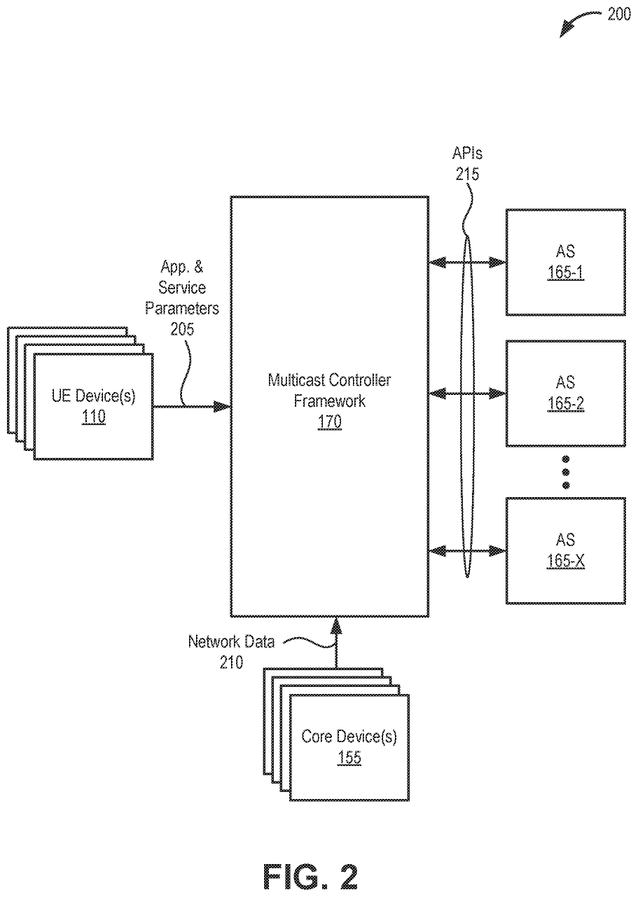

FIG. 2 is a diagram illustrating the role of multicast controller framework 170. As shown in FIG. 2, multicast controller framework 170 may receive application and service parameters 205 from UE devices 110. Application parameters and service parameters 205 may indicate, for example, parameters of a pending or active unicast stream. In one implementation, application and service parameters 205 may be included in an application wrapper generated by a system application running on UE device 110. The application wrapper may apply a management layer to the underlying application (e.g., a gaming application, video application, etc.), thus providing service parameters 205 without requiring changes to the underlying application. In another implementation, application and service parameters 205 may be generated directly by the application being used by the subscriber.

Application and service parameters 205 may include certain kinds of information depending on a particular use case. According to one implementation, each application (e.g., of a type where multicast services could be applicable) may provide application parameters and service parameters 205. Generally, application and service parameters 205 may include information to enable multicast controller framework 170 to determine if there is an opportunity to multicast content for multiple applications. For example, a multiplayer gaming application may identify the subscriber's service level, a platform (e.g., a game platform), a player mode (e.g., player vs. player), a server identifier (ID), a unique application instance (e.g., a unique game ID for a player vs, player game), and a player ID. In another example, an application may identify a UE device 110 receiving live content in a particular RAN sector.

Multicast controller framework 170 may receive network data 210 from one or more core devices 155. Network data 210 may include information about infrastructure components (e.g., MEC network 140) that are available to support the dynamic multicast service. Network data 210 may also include information indicating for which applications the dynamic multicast service is available.

Based on application and service parameters 205 and network data 210, multicast controller framework 170 may identify situations when the dynamic multicast service is available. For example, multicast controller framework 170 may identify UE devices 110 using a common application on common resources within network environment 100. In one implementation, multicast controller framework 170 may detect, from application and service parameters 205, unicast streams with common indicators, such as the same source, content ID, timing, etc. Multicast controller framework 170 may also review network data 210 to determine potential for local multicast groupings, such as geographically proximate traffic destinations and resource availability to support potential multicast streams. According to one implementation, multicast controller framework 170 may use a machine learning algorithm to dynamically detect multicast opportunities. When the application and service parameters 205 and network data 210 indicate an opportunity for multicast, multicast controller framework 170 may initiate communications with a corresponding AS 165. As described further herein, multicast controller framework 170 may provide information for AS 165 to consider triggering multicast streaming and enable consolidation of the identified unicast streams to multicast. According to another implementation, multicast controller framework 170 may recommend multicast opportunities to an application server only when network loads or congestion are above a threshold level.

Multicast controller framework 170 may communicate with ASs 165 via application programming interfaces (APIs) 215. According to one implementation, APIs 215 may interface AS 165 with multicast controller framework 170 via an NEF (e.g., one of core devices 155, not shown in FIG. 2). APIs 215 may also be used by ASs 165 to confirm multicast options and/or provide instructions. For example, AS 165 may use API 215 to opt-in to the dynamic multicast service for application-enabled multicast control. AS 165 may further use API 215 to identify an application and its corresponding service requirements (e.g., latency, bandwidth, etc.). For example, application server 165 may identify a service profile for an application that may include a latency value, a throughput value, a reliability value, a packet error rate, a bit rate (e.g., maximum bit rate (MBR), minimum bit rate, guaranteed bit rate (GBR)), a maximum data burst volume (MDBV), a jitter value, and/or similar types of information (e.g., key performance indicators (e.g., KPIs), a 5G QOS Identifier (5QI), a QoS Class Identifier (QCI), service level agreement (SLA) values, etc.).

Different application servers 165-1, 165-2, and 165-X may be suitable for different multicast scenarios. For example, a gaming application (e.g., AS 165-1) may be most likely to use the dynamic multicast service for UE devices 110 in the same RAN sector to receive content from AS 165-1. As another example, a V2X application (e.g., AS 165-2) may be most likely to use the dynamic multicast service for UE devices 110 in the same RAN sector to multicast to each other. As still another example, a video application (e.g., AS 165-X) may be most likely to use the dynamic multicast service for common streaming content within a community, region or nation.

Application servers 165 may receive from multicast controller framework 170 a recommendation initiate a multicast request and decide whether to act on the recommendation. Typically, it is in the best interest of both content providers and service providers to make use of multicast opportunities to conserve resources. However, for various service instances, application server 165 may determine not to act on a multicast opportunity. Application server 165 may confirm that a multicast recommendation is valid and, assuming the recommendation followed, the application server 165 may use information provided by multicast controller framework 170 to initiate a multicast stream. For example, in one implementation, application server 165 may consolidate existing unicast content streams (e.g., content1-a and content1-b) into a single multicast stream (e.g., content1) and provide the single multicast stream to a concentration point in network environment 100 as designated by multicast controller framework 170. The concentration point may be a network node at which point a common stream from the application server would be divided for multicast delivery.

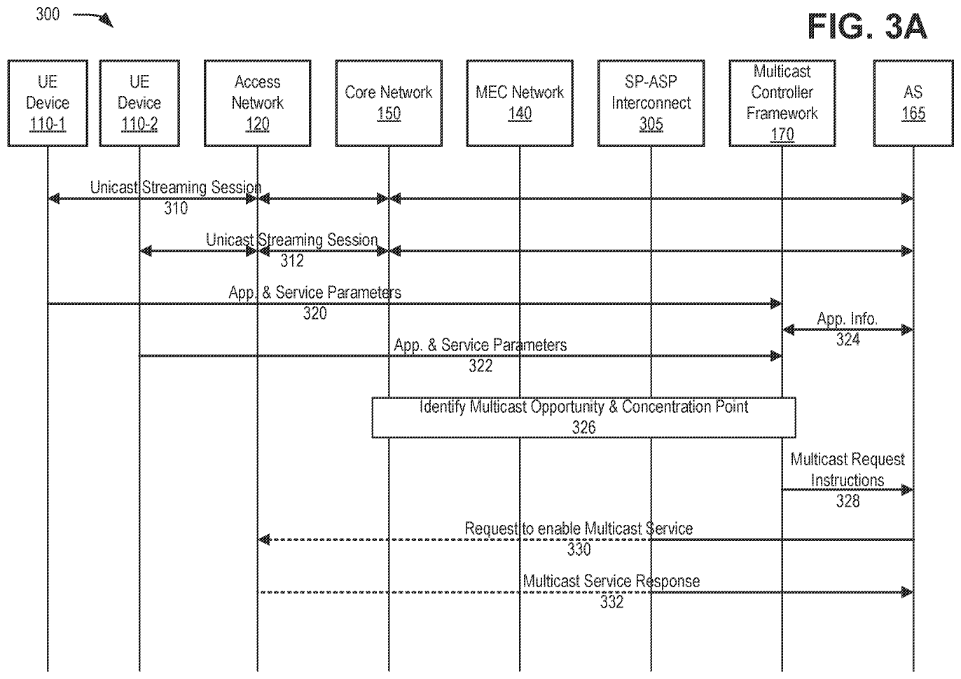

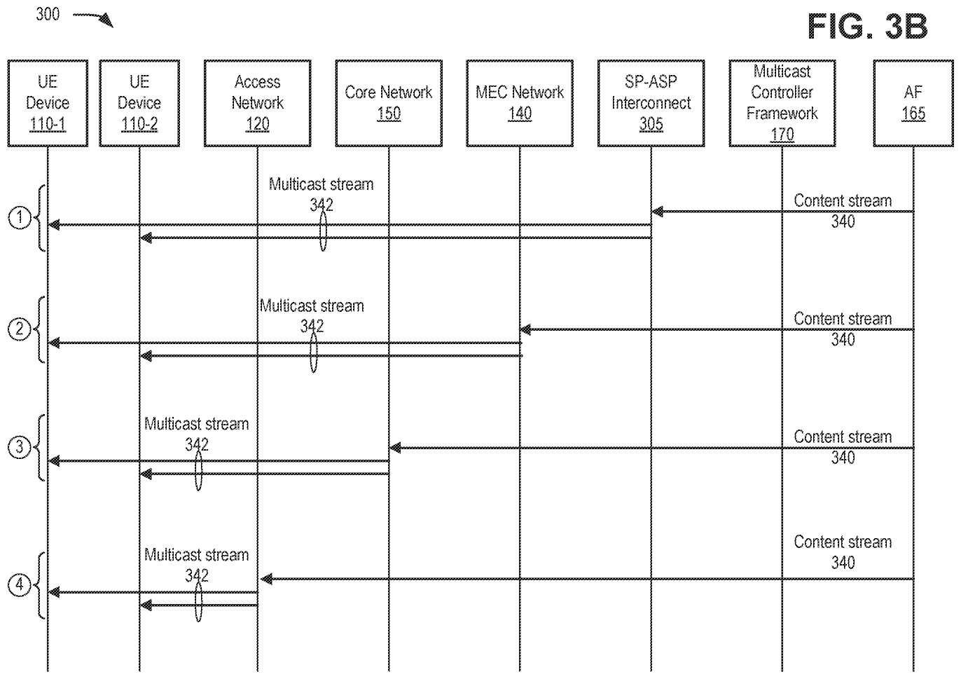

FIGS. 3A and 3B are signal flow diagrams illustrating communications in a portion 300 of network environment 100 to provide the dynamic multicast service. As shown in FIGS. 3A and 3B, network portion 300 may include UE devices 110-1 and 110-2, access network 120, core network 150, MEC network 140, a service provider (SP)-application service provider (ASP) interconnect 305, multicast controller framework 170, and an application server (AS) 165. SP-ASP Interconnect 305 may maintain a point of interconnect to a particular data network (e.g., data network 160) for an application server 165 to communicate with the mobile network. Communications shown in FIGS. 3A and 3B provide simplified illustrations of communications in network portion 300 and are not intended to reflect every signal or communication exchanged between devices/functions.

As shown in FIGS. 3A and 3B, UE device 110-1 may establish a unicast streaming session 310 with AS 165, and UE device 110-2 may establish a different unicast streaming session 312 with AS 165. In the example of FIGS. 3A and 3B, assume sessions 310 and 312 include the same content and timing (e.g., a live video streaming event, an in-game video clip, etc.) in which network resources could be conserved through use of a multicast stream.

UE device 110-1 may provide application and service parameters 320 to multicast controller framework 170. Similarly, UE device 110-2 may provide application and service parameters 322 to multicast controller framework 170. Application and service parameters 320 and 322 may include information multicast controller framework 170 needs to determine if an application running on UE device 110-1 and UE device 110-2 can benefit from the dynamic multicast service. Application and service parameters 320 and 322 may include, for example, information described above in connection with application and service parameters 205.

Application server 165 may use one of APIs 215 to indicate availability for the dynamic multicast service and to provide application information 324 to multicast controller framework 170. The application information 324 may include information described above in connection with APIs 215.

Based on application and service parameters 320 and 322 and application information 324, multicast controller framework 170 may identify 326 a multicast opportunity and a concentration point. For example, multicast controller framework 170 may identify that UE devices 110-1 and 110-2 are using a common application on common resources in network portion 300. In one implementation, multicast controller framework 170 may communicate with one or more of access devices 125, MEC devices 145, and/or core devices 155 to identify the multicast opportunity and the concentration point. The multicast opportunity may be an agreement that a multicast stream may be utilized for a particular time and/or a use case associated with an application running on UE 110-1 and UE 110-2, for example. The multicast concentration point may include, for example, the area of network portion 300 where multicast service can be applied to support the opportunity. For example, depending on a particular use case the concentration point may include one of SP-ASP Interconnect 305, MEC network 140, core network 150, or access network 120 (i.e., options 1, 2, 3, or 4, as described further in connection with FIG. 3B). Depending on the selected concentration point, multicast controller framework 170 may provide additional information relevant to the concentration point. For example, multicast controller framework 170 may also include Multi-User Multi-Input Multi-Output (MU-MIMO) and Application Aware Beam Grouping information for multicast at the RAN level. Multicast controller framework 170 may identify distributed control plane processing information and/or MEC service offerings.

Multicast controller framework 170 may provide to AS 165 multicast request instructions 328. The multicast request instructions 328 may indicate multicast capability offerings are available to application providers (e.g., AS 165) via an NEF. Multicast request instructions 328 may indicate the designated multicast option/concentration point via one of APIs 215.

AS 165 may receive multicast request instructions 328 and determine whether a multicast stream will be used for the identified opportunity. For example, based on multicast request instructions 328, AS 165 may generate a request 330 to enable multicast for designated service addresses (e.g., UE devices 110-1 and 110-2). Depending on the concentration point for the proposed multicast flow, request 330 may be directed to a concentration point at one of SP-ASP Interconnect 305, MEC network 140, core network 150, or access network 120. Although shown as a single request, depending on the multicast target address included in multicast request instructions 328, request 330 may pass through multiple network components (e.g., NEF, SMF, UPF, AMF, gNodeB, a PCE, etc.) to configure a multicast stream. The recipient of request 330 (e.g., SP-ASP Interconnect 305, MEC network 140, core network 150, or access network 120) may respond to request 330 with a multicast service response 332 confirming the service addresses and routing for the multicast content.

Referring to FIG. 3B, AS 165 may receive multicast service response 332 and may provide content for multicast streaming using the information from multicast service response 332. Depending on the instructions of multicast service response 332, AS 165 may provide a content stream 340 for one of four multicast scenarios (illustrated in FIG. 3B as circled numbers 1-4. Thus, unicast streams 310 and 312 may be aggregated into a single content stream 340 at one of multiple concentration point options.

In scenario 1, content stream 340 may be directed to SP-ASP interconnect 305, from which multicast streaming 342 may be enacted. In scenario 2, content stream 340 may be directed to MEC network 140, from which multicast streaming 342 may be enacted for UE devices 110 within the same MEC region, for example. In scenario 3, content stream 340 may be directed to core network 150, from which multicast streaming 342 may be coordinated for UE devices 110 on a national level. In scenario 4, content stream 340 may be directed to access network 120, from which multicast streaming 342 may be enacted for UE devices 110 within the same RAN sector, for example.

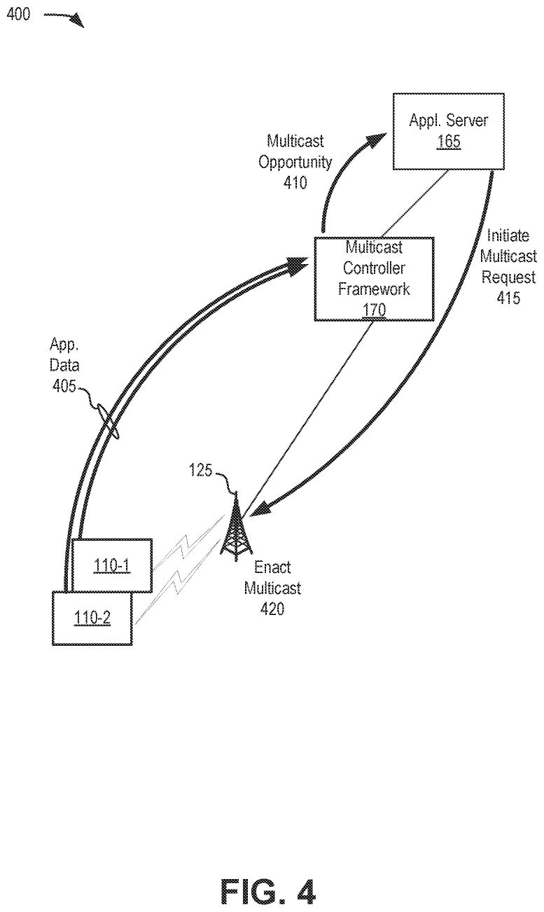

FIG. 4 is a diagram illustrating a use case for the dynamic multicast service. More particularly, FIG. 4 illustrates application-enabled multicast control for multi-user gameplay in a portion 400 of network environment 100. As shown in FIG. 4, network portion 400 includes UE devices 110-1 and 110-2, access device 125, multicast controller framework 170, and application server 165. FIG. 4 provides a simplified illustration of communications in network portion 400 and is not intended to reflect every signal, communication, or intermediate points for exchanges between functions/devices.

In FIG. 4, assume UE device 110-1 and UE device 110-2 are used to play a multi-player game, with each other while located in a common space. The gaming application may include, for example, cutscenes or other cinematic sequences that may be viewed simultaneously by each player. In other words, apart from the actual game play, there may be sequences of common video content that will be presented to both users (e.g., during transitions between levels, introductory content, etc.). The common video content within the game may provide a multicast opportunity. For example, UE device 110-1 and UE device 110-2 may be used by users in the same vehicle to play the game together. As another example, UE device 110-1 and UE device 110-2 may be used by players attending a gaming convention.

To provide application-enabled multicast control, UE device 110-1 and UE device 110-2 may provide application data 405 (e.g., corresponding to application and service parameters 205) to multicast controller framework 170. In one implementation, application data 405 from each UE device 110 may include an application wrapper indicating, for example, a service level indicator (e.g., Game Booster), a platform (e.g., Xbox), a game mode (e.g., Player vs. Player), an application server 165 identifier (e.g., Xbox Server ID), a Player vs. Player Unique Game ID, and a player ID. Multicast controller framework 170 may detect commonality between the application data from UE device 110-1 and UE device 110-2 and identify a multicast opportunity. Multicast controller framework 170 may inform the application server 165 of the multicast opportunity 410 (e.g., corresponding to multicast request instructions 328), which may provide a target address for application server 165 to trigger multicast. In response to multicast opportunity 410, application server 165 may provide a multicast request 415 to access device 125, and access device 125 may start multicast streaming to UE device 110-1 and UE device 110-2 for common aspects of the application (e.g., the cutscenes).

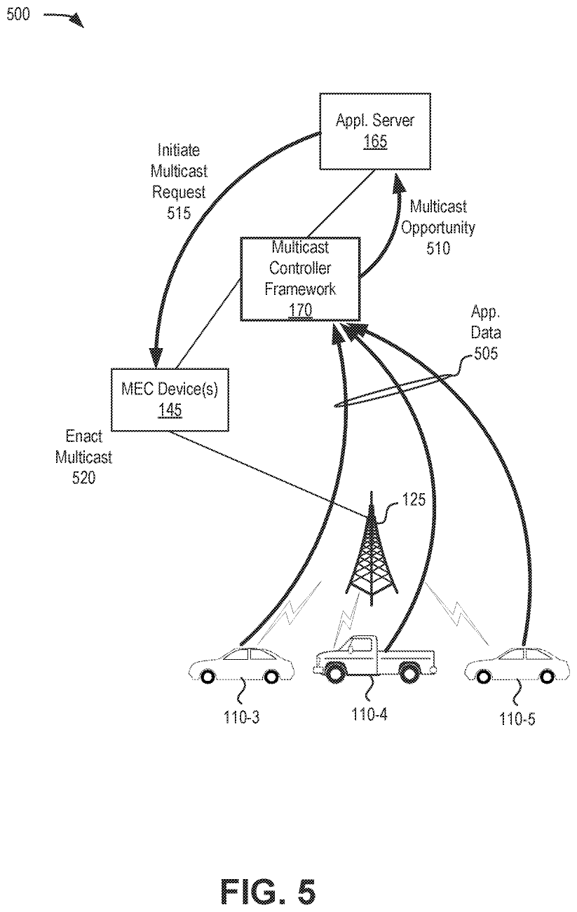

FIG. 5 is a diagram illustrating another use case for the dynamic multicast service. More particularly, FIG. 5 illustrates application-enabled multicast control for a multiuser vehicle control plane in a portion 500 of network environment 100. As shown in FIG. 5, network portion 500 includes UE devices 110-3 through 110-5, access device 125, MEC device 145, multicast controller framework 170, and application server 165. FIG. 5 provides a simplified illustration of communications in network portion 500 and is not intended to reflect every signal, communication, or intermediate points for exchanges between functions/devices.

In FIG. 5, assume UE devices 110-3, 110-4, and 110-5 include a vehicle video application, such as for a V2X system, and are located in the same RAN sector. The video application allows for a multi-user experience to avoid unforeseen issues. For example, the vehicle associated with UE device 110-3 may be ahead of the vehicles associated with UE devices 110-4 and 110-5. Captured data from UE devices 110-4 and 110-5 can be shared with UE device 110-3 to supplement the video feed of UE device 110-3. As another example, the vehicle associated with UE device 110-5 may be behind the vehicles associated with UE devices 110-3 and 110-4. Captured data from UE device 110-3 can be shared with UE devices 110-4 and 110-5 to supplement the video feed of UE devices 110-4 and 110-5.

To provide application-enabled multicast control, UE devices 110-3, 110-4, and 110-5 may provide application data 505 (e.g., corresponding to application and service parameters 205) to multicast controller framework 170. In one implementation, application data 505 from each UE device 110 may include an application wrapper indicating, for example, a service type indicator (e.g., V2X), a platform (e.g., V2X video), and a unique viewer ID. Multicast controller framework 170 may detect that the application data 505 includes multiuser video and identify a multicast opportunity. Multicast controller framework 170 may inform the application server 165 of the multicast opportunity 510 (e.g., corresponding to multicast request instructions 328), which may provide a target address of MEC device 145 to trigger multicast. In response to multicast opportunity 510, application server 165 may provide a multicast request 515 to MEC device 145, and MEC device 145 may start a multicast streaming 520 to UE devices 110-3, 110-4, and 110-5 for the application (e.g., multi-user video). Thus, application server 165 (e.g., a third-party application provider may enable and establish multicast streams among UE devices 110-3, 110-4, and 110-5.

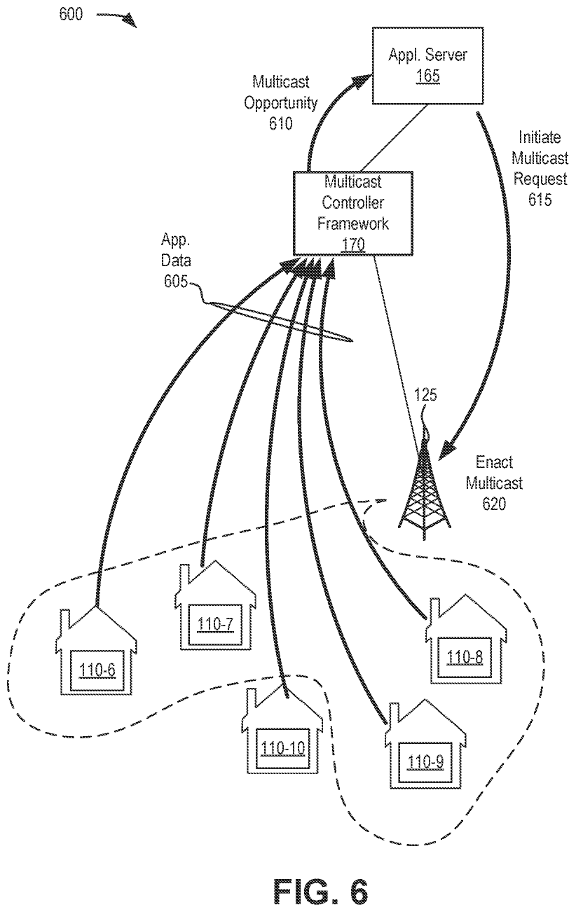

FIG. 6 is a diagram illustrating another use case for the dynamic multicast service. More particularly, FIG. 6 illustrates application-enabled multicast control for a large-scale video distribution in a portion 600 of network environment 100. As shown in FIG. 6, network portion 600 includes UE devices 110-6 through 110-10, access device 125, core device 155, multicast controller framework 170, and application server 165. FIG. 6 provides a simplified illustration of communications in network portion 600 and is not intended to reflect every signal, communication, or intermediate points for exchanges between functions/devices.

In FIG. 6, assume UE devices 110-6 through 110-10 are FWA CPE devices. Typically, for FWA CPE, even when receiving the same content, such as sports broadcasts (e.g., the Super Bowl), each FWA device consumes its own radio resources. According to implementations described herein, multicast controller framework 170 may indicate to the access device 125 (e.g., a gNodeB) the content parameters to allow access device 125 to group similar devices together into beam groups and apply the appropriate beamforming algorithms. In the example of FIG. 6, access device 125 may group UE devices 110-6 through 110-9, which are presenting the same broadcast stream, in a beamforming group and use only one unit of Radio Resource transmitted to all four devices (instead of needing four units). The multicast content will also increase the viability of the MU-MIMO on this use case. In this way, the dynamic multicast service not only leverages MU-MIMO, which is already functional regardless of unicast/multicast, but extends its viability and capacity saving value.

To provide application-enabled multicast control, UE devices 110-6 through 110-10 may provide application data 605 (e.g., corresponding to application and service parameters 205) to multicast controller framework 170. Application data 605 from each UE device 110 may include an application wrapper indicating, for example, a live event content stream (e.g., a Super Bowl live stream). Assume UE devices 110-6 through 110-9 are using a video application to live-stream the same event. Multicast controller framework 170 may detect that the application data 605 includes multiuser video with fixed location devices and identify a multicast opportunity. Multicast controller framework 170 may inform the application server 165 of the multicast opportunity 610 (e.g., corresponding to multicast request instructions 328), which may provide a target address of access device 125 to trigger multicast. In response to multicast opportunity 610, application server 165 may provide a multicast request 615 to access device 125, and access device 125 may enact multicast streaming 620 to UE devices 110-6 through 110-9 for the selected video application. The dynamic beamforming group may end with the conclusion of the live-stream event. The detection of fixed location devices and application content allows for stable groupings.

FIG. 7 is a diagram illustrating exemplary components of a device 700 that may correspond to one or more of the devices described herein. For example, device 700 may correspond to components included in access network 120, backhaul network 130, MEC network 140, core network 150, data network 160, multicast controller framework 170, UE devices 110, and/or other elements illustrated in FIGS. 1-6. As illustrated in FIG. 7, according to an exemplary embodiment, device 700 includes a bus 705, one or more processors 710, memory/storage 715 that stores software 720, a communication interface 725, an input 730, and an output 735. According to other embodiments, device 700 may include fewer components, additional components, different components, and/or a different arrangement of components than those illustrated in FIG. 7 and described herein.

Bus 705 includes a path that permits communication among the components of device 700. For example, bus 705 may include a system bus, an address bus, a data bus, and/or a control bus. Bus 705 may also include bus drivers, bus arbiters, bus interfaces, and/or clocks.

Processor 710 includes one or multiple processors, microprocessors, data processors, co-processors, application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, and/or some other type of component that interprets and/or executes instructions and/or data. Processor 710 may be implemented as hardware (e.g., a microprocessor, etc.), a combination of hardware and software (e.g., a SoC, an ASIC, etc.), may include one or multiple memories (e.g., cache, etc.), etc. Processor 710 may be a dedicated component or a non-dedicated component (e.g., a shared resource).

Processor 710 may control the overall operation or a portion of operation(s) performed by device 700. Processor 710 may perform one or multiple operations based on an operating system and/or various applications or computer programs (e.g., software 720). Processor 710 may access instructions from memory/storage 715, from other components of device 700, and/or from a source external to device 700 (e.g., a network, another device, etc.). Processor 710 may perform an operation and/or a process based on various techniques including, for example, multithreading, parallel processing, pipelining, interleaving, etc.

Memory/storage 715 includes one or multiple memories and/or one or multiple other types of storage mediums. For example, memory/storage 715 may include one or multiple types of memories, such as, random access memory (RAM), dynamic random access memory (DRAM), cache, read only memory (ROM), a programmable read only memory (PROM), a static random access memory (SRAM), a single in-line memory module (SIMM), a dual in-line memory module (DIMM), a flash memory (e.g., a NAND flash, a NOR flash, etc.), and/or some other type of memory. Memory/storage 715 may include a hard disk (e.g., a magnetic disk, an optical disk, a magneto-optic disk, a solid state disk, etc.), a Micro-Electromechanical System (MEMS)-based storage medium, and/or a nanotechnology-based storage medium. Memory/storage 715 may include a drive for reading from and writing to the storage medium.

Memory/storage 715 may be external to and/or removable from device 700, such as, for example, a Universal Serial Bus (USB) memory stick, a dongle, a hard disk, mass storage, off-line storage, network attached storage, or some other type of storing medium. Memory/storage 715 may store data, software, and/or instructions related to the operation of device 700.

Software 720 includes an application or a program that provides a function and/or a process. Software 720 may include an operating system. Software 720 is also intended to include firmware, middleware, microcode, hardware description language (HDL), and/or other forms of instruction. For example, according to an implementation, software 720 may implement portions of multicast controller framework 170.

Communication interface 725 permits device 700 to communicate with other devices, networks, systems, devices, and/or the like. Communication interface 725 includes one or multiple wireless interfaces and/or wired interfaces. For example, communication interface 725 may include one or multiple transmitters and receivers, or transceivers (e.g., radio frequency transceivers). Communication interface 725 may include one or more antennas. For example, communication interface 725 may include an array of antennas. Communication interface 725 may operate according to a protocol stack and a communication standard. Communication interface 725 may include various processing logic or circuitry (e.g., multiplexing/de-multiplexing, filtering, amplifying, converting, error correction, etc.).

Input 730 permits an input into device 700. For example, input 730 may include a keyboard, a mouse, a display, a button, a switch, an input port, speech recognition logic, a biometric mechanism, a microphone, a visual and/or audio capturing device (e.g., a camera, etc.), and/or some other type of visual, auditory, tactile, etc., input component. Output 735 permits an output from device 700. For example, output 735 may include a speaker, a display, a light, an output port, and/or some other type of visual, auditory, tactile, etc., output component. According to some embodiments, input 730 and/or output 735 may be a device that is attachable to and removable from device 700.

Device 700 may perform a process and/or a function, as described herein, in response to processor 710 executing software 720 stored by memory/storage 715. By way of example, instructions may be read into memory/storage 715 from another memory/storage 715 (not shown) or read from another device (not shown) via communication interface 725. The instructions stored by memory/storage 715 cause processor 710 to perform a process described herein. Alternatively, for example, according to other implementations, device 700 performs a process described herein based on the execution of hardware (processor 710, etc.).

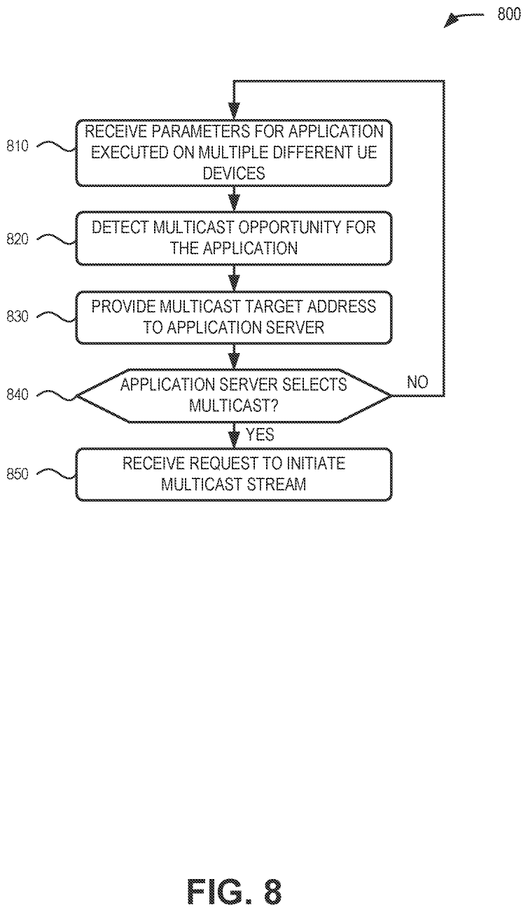

FIG. 8 is a flow diagram illustrating an exemplary process 800 for providing a dynamic multicast service, according to an implementation described herein. In one implementation, process 800 may be implemented by multicast controller framework 170. In another implementation, process 800 may be implemented by multicast controller framework 170 in conjunction with one or more other network elements in network portion 300.

Process 800 may include receiving parameters for an application executed on multiple different UE devices (block 810). For example, as described in FIG. 2, multicast controller framework 170 may receive application and service parameters 320 from UE device 110-1. Multicast controller framework 170 may also receive application and service parameters 322 from UE device 110-2.

Process 800 may also include detecting a multicast opportunity for the application based on the received parameters (block 820). For example, multicast controller framework 170 may review application and service parameters 320 and application and service parameters 322 to identify multicast opportunities for applications that have opted-in to the dynamic multicast service. For example, multicast controller framework 170 may identify UE devices using a common application on common (e.g., the same) resources in a mobile network. Alternatively, multicast controller framework 170 may identify vehicles communicating in the same RAN sector for the same content. Using information from core network 150, multicast controller framework 170 may identify available network resources, conditions, and configurations to support the multicast opportunity.

Process 800 may further include providing, to the application server, a multicast target address to initiate multicast streaming for the application (block 830). For example, multicast controller framework 170 may send to application server 165 (e.g., serving UE devices 110-1 and 110-2), a multicast target address to initiate multicast streaming of particular content to UE devices 110-1 and 110-2.

Process 800 may additionally include determining whether to select the multicast option (block 840). For example, application server 165 may receive the multicast target address from multicast controller framework 170 and determine whether to use multicast for the identified situation. If the multicast option is not selected by the application server (block 840—No), process 800 may return to process block 810 to look for other multicast opportunities.

If the multicast option is selected by the application server (block 840—Yes), process 800 may include receiving a request from the application server to initiate the multicast stream (block 850). For example, as described in connection with FIG. 3, application server 165 may use the multicast target address to direct multicast instructions to the appropriate concentration point in the network for a multicast stream of particular content. A device at the concentration point (e.g., SP-ASP Interconnect 305, MEC network 140, core network 150, or access network 120) may receive the multicast instructions from application server 165 and implement the multicast service.

Systems and methods described herein provide for application-enabled multicast control. A network device may receive first parameters for an application executed on a first UE device and may receive second parameters for the application executed on a second UE device. The network device may detect, based on the first and second parameters, a multicast opportunity for the application and may provide, to an application server for the first and second UE device, a multicast target address to initiate multicast streaming to the first UE device and the second UE device.

As set forth in this description and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. Thus, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while a series of signals and blocks have been described with regard to the processes illustrated in FIGS. 2, 3A, 3B, and 4-6. the order of the signals and blocks may be modified according to other embodiments. Further, non-dependent signals or blocks may be performed in parallel. Additionally, other processes described in this description may be modified and/or non-dependent operations may be performed in parallel.

Embodiments described herein may be implemented in many different forms of software executed by hardware. For example, a process or a function may be implemented as “logic,” a “component,” or an “element.” The logic, the component, or the element, may include, for example, hardware or a combination of hardware and software.

Embodiments have been described without reference to the specific software code because the software code can be designed to implement the embodiments based on the description herein and commercially available software design environments and/or languages. For example, various types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 710) of a device. A non-transitory storage medium includes one or more of the storage mediums described in relation to memory 715.

To the extent the aforementioned embodiments collect, store or employ personal information of individuals, it should be understood that such information shall be collected, stored and used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such. All structural and functional equivalents to the elements of the various aspects set forth in this disclosure that are known or later come to be known are expressly incorporated herein by reference and are intended to be encompassed by the claims.

What is claimed is:

1. A method, comprising:
receiving, by a network device, first parameters for an application executed on a first user equipment (UE) device;
receiving, by the network device, second parameters for the application executed on a second UE device;
detecting, by the network device and based on the first and second parameters, a multicast opportunity for the application; and
providing, by the network device and to an application server for the first UE device and the second UE device, a multicast target address to initiate multicast streaming to the first UE device and the second UE device.

2. The method of claim 1, wherein detecting the multicast opportunity for the application comprises:
identifying that the first UE device and the second UE device are using the application on common resources in a mobile network.

3. The method of claim 1, wherein the first parameters and the second parameters identify a same live video event.

4. The method of claim 1, wherein the first parameters and the second parameters identify a unique application instance.

5. The method of claim 1, wherein a network component that has the multicast target address initiates multicast streams between the first UE device and the second UE device.

6. The method of claim 1, further comprising:
receiving, by the network device, network data for devices to support a multicast service.

7. The method of claim 1, wherein the network device includes an application function within a core network.

8. The method of claim 1, wherein a network component that has the multicast target address includes a multicast concentration point at one of:
a multi-access edge computing (MEC) network;
a core network; or
an access network.

9. The method of claim 1, wherein detecting the multicast opportunity for the application further includes:
detecting multi-user multi-input multi-output (MU-MIMO) network capabilities at the multicast target address.

10. A network device, comprising:
a processor configured to:
receive first parameters for an application executed on a first user equipment (UE) device;
receive second parameters for the application executed on a second UE device;
detect, based on the first and second parameters, a multicast opportunity for the application; and
provide, to an application server for the first UE device and the second UE device, a multicast target address to initiate multicast streaming to the first UE device and the second UE device.

11. The network device of claim 10, wherein, when detecting the multicast opportunity, the processor is further configured to:
identify that the first UE device and the second UE device are using the application on common resources in a mobile network.

12. The network device of claim 10, wherein the first parameters and the second parameters identify a same live video event.

13. The network device of claim 10, wherein the first parameters and the second parameters include a unique application instance.

14. The network device of claim 10, wherein, when providing the multicast target address to initiate multicast streaming, the processor is configured to provide instructions to configure multicast streams between the first UE device and the second UE device.

15. The network device of claim 10, wherein the processor is further configured to:
receive network data for devices to support a multicast service.

16. The network device of claim 10, wherein the network device includes an application function within a core network.

17. A non-transitory computer-readable medium containing instructions executable by at least one processor, the computer-readable medium comprising one or more instructions for:
receiving, by a network device, first parameters for an application executed on a first user equipment (UE) device;
receiving, by the network device, second parameters for the application executed on a second UE device;
detecting, by the network device and based on the first and second parameters, a multicast opportunity for the application; and
providing, by the network device and to an application server for the first UE device and the second UE device, a multicast target address to initiate multicast streaming to the first UE device and the second UE device.

18. The non-transitory computer-readable medium of claim 17, wherein the first parameters or the second parameters are included in an application wrapper.

19. The non-transitory computer-readable medium of claim 17, wherein the instructions for providing the multicast target address to initiate multicast streaming further includes instructions to configure multicast streams between the first UE device and the second UE device.

20. The non-transitory computer-readable medium of claim 17, further comprising one or more instructions for:
receiving, from the application server, an opt-in request for application-enabled multicast control; and
receiving network data for devices to support multicast delivery.
